(19) United States
(12) Patent Application Publication
(10) Pub. No.: US 2025/0029989 A1
(43) Pub. Date: Jan. 23, 2025

(54) POSITIVE ELECTRODE SHEET AND APPLICATION THEREOF

(71) Applicant: ZHUHAI COSMX BATTERY CO., LTD., Zhuhai (CN)

(72) Inventor: Fan YANG, Zhuhai (CN)

(21) Appl. No.: 18/908,496

(22) Filed: Oct. 7, 2024

(30) Foreign Application Priority Data
Oct. 8, 2023 (CN) 202311290571.9

(51) Int. Cl. H01M 4/36; H01M 4/02; H01M 4/131; H01M 4/525; H01M 4/62; H01M 10/0525

(52) U.S. Cl. CPC H01M 4/366; H01M 4/131; H01M 4/525; H01M 4/623; H01M 4/625; H01M 10/0525; H01M 2004/021; H01M 2004/028

(57) ABSTRACT

A positive electrode sheet and application thereof, where the positive electrode sheet includes a positive electrode current collector, an undercoat layer and a positive electrode active layer, the undercoat layer being located on at least one surface of the positive electrode current collector, and the positive electrode active layer being located on a surface of the undercoat layer far away from the positive electrode current collector; where, the undercoat layer includes a first carbon material, and a powder resistivity of the first carbon material is not lower than 0.2 Ω·cm. The undercoat layer included in the positive electrode sheet of the present application has high impedance, and when mechanical abuse occurs, the lithium-ion battery is not prone to thermal runaway, effectively improving the safety of battery.

### CROSS-REFERENCE TO RELATED APPLICATION

This present application claims priority to Chinese Patent Application No. 2023112905719, filed on Oct. 8, 2023, which is hereby incorporated by reference in its entirety.

### TECHNICAL FIELD

The present application belongs to the field of lithium-ion battery and relates to a positive electrode sheet, in particular to a positive electrode sheet and an application thereof.

### BACKGROUND

Lithium-ion batteries have been widely used in various fields of life and production because they have high energy density, long cycle life, and light weight, and are energy-saving and environmentally-friendly. However, the lithium-ion battery will inevitably encounter mechanical abuse in the service process. During this process, the lithium-ion battery will be deformed under the action of external force, the isolation film will be destroyed, and the positive electrode current collector will contact with the negative electrode active material, causing internal short circuit of the battery. Because the short-circuit resistance is close to the internal resistance of the battery, the short-circuit point has a large discharge power, and the short-circuit position will be rapidly heated up, leading to thermal runaway, even catastrophic consequences such as fire and explosion, which has a certain safety risk and needs to be improved.

### SUMMARY

In view of the above defects, the present application provides a positive electrode sheet including an undercoat layer, and the undercoat layer has the characteristic of high impedance, so that the lithium-ion battery is not prone to thermal runaway in the process of mechanical abuse, thereby effectively improving its safety.

The present application provides a lithium-ion battery, which includes the positive electrode sheet. The lithium-ion battery has high safety performance.

The present application provides a positive electrode sheet, including a positive electrode current collector, an undercoat layer and a positive electrode active layer, the undercoat layer being located on at least one surface of the positive electrode current collector, and the positive electrode active layer being located on a surface of the undercoat layer far away from the positive electrode current collector;
the undercoat layer includes a first carbon material;
a powder resistivity of the first carbon material is not lower than 0.26 Ω·cm.

Further, the powder resistivity of the first carbon material is 0.2-100 Ω·cm, and/or an areal density of the undercoat layer is 0.5-14 g/m².

Further, the undercoat layer includes a binder;
a mass percentage content of the binder in the undercoat layer is 6-60 wt %; and/or,
the binder includes at least one of polyvinylidene fluoride, polytetrafluoroethylene, polyacrylic acid, polyamide, lithium polyacrylate, methacrylate, sodium carboxymethyl cellulose and aluminum dihydrogen phosphate.

Further, a median particle size of the first carbon material is ≤1000 nm;
and/or a carbon content of the first carbon material is more than 80%;
and/or a mass percentage content of the first carbon material in the undercoat layer is not lower than 40%.

Further, the undercoat layer further includes a second carbon material; a powder resistivity of the second carbon material is <0.2 Ω·cm;
and/or a median particle size of the second carbon material is ≤1000 nm;
and/or a mass percentage content of the second carbon material in the undercoat layer is not greater than 20%.

Further, a mass percentage content of the first carbon material is greater than that of the second carbon material in the undercoat layer;
a mass ratio of the second carbon material to the first carbon material is (0:100)-(40:100);
and/or, the undercoat layer includes the following components by the mass percentage content: 40-94% of the first carbon material, 0-20% of the second carbon material and 6-60% of a binder.

Further, an area proportion of the undercoat layer relative to the surface of the positive electrode current collector is ≥40%, and/or a thickness of the undercoat layer is ≤8 μm.

Further, the first carbon material includes at least one of carbon black, hard carbon, artificial graphite, natural graphite, carbon quantum dot, carbon fiber, carbon nanotube, carbon nanowire and graphene;
and/or the second carbon material includes at least one of carbon black, hard carbon, artificial graphite, natural graphite, carbon quantum dot, carbon fiber, carbon nanotube, carbon nanowire and graphene.

Further, the positive electrode active layer includes a positive electrode active material;
the positive electrode active material includes at least one of lithium cobaltate, lithium nickelate, lithium nickel cobalt manganate, lithium manganate, lithium nickel manganate, lithium nickel cobalt aluminate, lithium ferric phosphate, lithium ferric manganese phosphate and lithium-rich manganese-based material.

The present application also provides a lithium-ion battery, which includes the positive electrode sheet described in any one of the above.

The positive electrode sheet of the present application includes the undercoat layer with the first carbon material, and the resistivity of the first carbon material is high, so that the short-circuit point resistance can be increased when mechanical abuse occurs, the violent reaction during short-circuit is avoided, the reaction degree is weakened, and the safety performance of the lithium-ion battery is effectively improved.

### BRIEF DESCRIPTION OF DRAWINGS

FIG. 1 is a cross-sectional view of the positive electrode sheet according to one embodiment of the present application.

FIG. 2 is a cross-sectional view of the positive electrode sheet according to another embodiment of the present application.

### DESCRIPTION OF THE REFERENCE NUMERALS

1—positive electrode current collector;
2—undercoat layer;
3—positive electrode active layer.

### DESCRIPTION OF EMBODIMENTS

In order to make the object, technical solution and advantages of the present application more clear, the technical solution in embodiments of the present application is hereinafter described clearly and completely with reference to the embodiments of the present application. It is evident that the embodiments described are only a part of the embodiments of the present application, not all of the embodiments. Based on embodiments of the present application, all other embodiments obtained by those skilled in the art without any creative labor also fall within the protection scope of the present application.

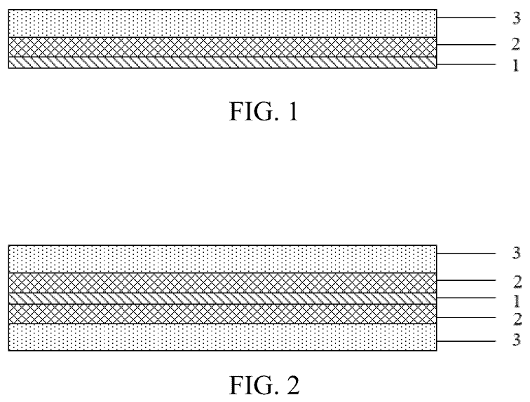

In a first aspect, the present application provides a positive electrode sheet, as shown in FIG. 1 and FIG. 2, including a positive electrode current collector 1, an undercoat layer 2 and a positive electrode active layer 3, the undercoat layer 2 being located on at least one surface of the positive electrode current collector 1 and the positive electrode active layer 3 being located on a surface of the undercoat layer 2 far away from the positive electrode current collector 1; the undercoat layer 2 includes a first carbon material, and a powder resistivity of the first carbon material is not lower than 0.2 Ω·cm.

Specifically, as shown in FIG. 1, the positive electrode current collector 1 has two surfaces in its thickness direction. In an embodiment, the undercoat layer 2 is arranged on one surface of the positive electrode current collector 1, and the other surface of the positive electrode current collector 1 is not provided with any functional layer.

In another embodiment, as shown in FIG. 2, the undercoat layer 2 is disposed on both surfaces of the positive electrode current collector 1, and the positive electrode active layer 3 is disposed on the surface of the undercoat layer 2.

The first carbon material in the present application is obtained by surface treatment performed on carbon material or conventional preparation means. Specifically, the surface treatment of carbon material can be implemented by surface adsorption modification to adsorb an organic acid or an organic base on the surface of the carbon material, where the organic acid may be selected from at least one of oxalic acid, succinic acid, acetic acid and benzoic acid, and the organic base, may be selected from at least one of organic amines, pyridines, indoles and the like; the surface of carbon material can also be modified by coating a layer of insulating material through mechanical mixing, solid-phase reaction, hydrothermal method, sol-gel method, precipitation method, heterogeneous coagulation method, emulsion coating method, chemical vapor deposition method, spray pyrolysis method, etc., where the insulating material may be selected from at least one of polypropylene, polyurethane and silicon oxide; the surface of carbon material can also be oxidized by oxidation modification through introducing hydroxyl or carboxyl functional groups to the surface of carbon material to improve the insulation of carbon material; the morphology and structure of the carbon material can also be changed by ball milling or ultrasonic treatment to reduce its conductivity; the carbon material includes at least one of carbon black, hard carbon, artificial graphite, natural graphite, carbon quantum dot, carbon fiber, carbon nanotube, carbon nanowire and graphene.

The positive electrode current collector 1 in the present application may be selected from any one of aluminum current collector, nickel current collector, stainless steel current collector, metal material and polymer composite current collector.

According to the present application, the undercoat layer 2 is arranged between the positive electrode current collector 1 and the positive electrode active layer 3, where the undercoat layer 2 includes the first carbon material having a relatively high resistivity, which improves the film sheet resistance of the positive electrode sheet effectively. In this way, in the case of mechanical abuse, the lithium-ion battery including the positive electrode sheet can not only reduce the contact between the positive electrode current collector 1 and the positive electrode active layer 3, but also improve the resistance at short-circuit point, thereby enhancing the safety of the lithium-ion battery.

In a specific embodiment, the powder resistivity of the first carbon material is 0.2-100 Ω·cm. In this range, the undercoat layer 2 including the first carbon material has a better protective effect, which further improves the safety performance of the battery when mechanical abuse occurs, and at the same time, a cycle performance of the lithium-ion battery will not deteriorate too much.

In a specific embodiment, an areal density of the undercoat layer 2 is 0.5-14 g/m². In this range, the undercoat layer 2 contains enough first carbon material, which can achieve better impedance effect and effectively improve the safety performance of the lithium-ion battery when mechanical abuse occurs.

In a specific embodiment, the undercoat layer 2 further includes a binder; a mass percentage content of the binder in the undercoat layer 2 is 6-60%. When the binder is in the above range, a large bonding force can be formed between the undercoat layer 2 and the positive electrode current collector 1, and the undercoat layer 2 is not easy to fall off when mechanical abuse occurs, thus achieving the purpose of long-term protection.

Further, the binder in the undercoat layer 2 includes at least one of polyvinylidene fluoride, polytetrafluoroethylene, polyacrylic acid, polyamide, lithium polyacrylate, methacrylate, sodium carboxymethyl cellulose and aluminum dihydrogen phosphate. When the binder is a mixture of a plurality of specific compounds, the proportion of each specific compound is not specifically limited in the present application.

In a specific embodiment, a median particle size of the first carbon material is ≤1000 nm. Within this range, the smaller the particle size of the first carbon material is, the easier it is for the first carbon material to move to the short circuit point when mechanical abuse occurs, blocking the possible direct short circuit between the positive electrode current collector 1 and the negative electrode active material, and increasing the resistance during short circuit, thus improving the safety performance.

In a specific embodiment, a carbon content of the first carbon material is more than 80%. In this range, the first carbon material has a high impedance, and correspondingly, the impedance of the formed undercoat layer 2 is high, so that the positive electrode sheet including the undercoat layer 2 is less prone to failure in the process of mechanical abuse.

In a specific embodiment, a mass percentage content of the first carbon material in the undercoat layer 2 is not lower than 40%. In this range, the content of the first carbon material in the undercoat layer 2 will not be too small, and then the content of the binder will not be too much. At this point, the positive electrode sheet has good toughness, and the bonding force between the undercoat layer 2 and the positive electrode current collector 1 is large, which makes it difficult to fall off during mechanical abuse. At the same time, the undercoat layer 2 also has a good impedance effect, which can significantly improve the safety performance of lithium-ion battery when mechanical abuse occurs.

In this application, a mass percentage content of the first carbon material in the undercoat layer 2 of not lower than 40% means to be based on a total mass of other components excluding the second carbon material (i.e., the first carbon material and the binder) in the undercoat layer 2.

In a specific embodiment, the undercoat layer 2 further includes a second carbon material; a powder resistivity of the second carbon material is <0.2 Ω·cm. When the resistivity of the selected first carbon material is too large, for example, the resistivity of the selected first carbon material is higher than 20 Ω·cm, it will affect the cycle performance of lithium-ion battery to some extent. At this point, a proper amount of the second carbon material with low resistivity may be added to provide enough conductive network to avoid polarization increase and capacity attenuation during normal charge and discharge of the battery and optimize the cycle performance of the lithium-ion battery.

The source of the second carbon material is not particularly limited in the present application, and the second carbon material may be obtained by natural mining or conventional preparation means, for example.

In a specific embodiment, the median particle size of the second carbon material is equal to or less than 1000 nm in order to avoid the particle size of the second carbon material being too large, which may cause the undercoat layer 2 to be uneven and prevent the formation of a thin undercoat layer 2.

In a specific embodiment, the mass percentage content of the second carbon material in the undercoat layer 2 is not greater than 20%. When the content of the second carbon material is too high, the electronic insulation of the undercoat layer 2 will be poor, and the safety performance of the battery will be significantly reduced. At the same time, because there are too many non-oxidized catalytic sites on the surface of the second carbon material, gas may be generated during high-temperature cycle or high-temperature storage of the battery, which may cause the battery cell to swell or cause the cycle attenuation of battery to increase.

In a specific embodiment, a mass percentage content of the first carbon material in the undercoat layer 2 is greater than that of the second carbon material; further, the mass ratio of the second carbon material to the first carbon material is (0:100)-(40:100). At this point, the undercoat layer 2 including the first carbon material and the second carbon material not only has high impedance, but also has enough conductive network, so that the lithium-ion battery including the undercoat layer 2 has better safety performance and cycle performance.

In a specific embodiment, the undercoat layer 2 includes, in percentage by mass, 40-94% of the first carbon material, 0-20% of the second carbon material and 6-60% of a binder. When the contents of the first carbon material, the second carbon material and the binder are in the above ranges respectively, the formed undercoat layer 2 is not easy to fall off during mechanical abuse, and the positive electrode current collector 1 is not easy to be exposed, so that the lithium-ion battery including the undercoat layer 2 has good cycle performance and safety performance.

In a specific embodiment, an area proportion of the undercoat layer 2 on the surface of the positive electrode current collector 1 is ≥40%. At this point, in the process of mechanical abuse, due to the existence of the undercoat layer 2, the short-circuit process is interrupted instead of continuous short-circuit, which greatly reduces the probability of thermal runaway, improves the safety of lithium-ion battery in the process of mechanical abuse, and also saves costs and reduces the thickness of lithium-ion battery.

In a specific embodiment, a thickness of the undercoat layer 2 is ≤8 μm, and the thickness of the undercoat layer 2 is ≤5 μm. At this point, the undercoat layer 2 has good safety performance and high energy density, which can reduce the energy density loss caused by this layer.

In a specific embodiment, the first carbon material includes at least one of carbon black, hard carbon, artificial graphite, natural graphite, carbon quantum dot, carbon fiber, carbon nanotube, carbon nanowire and graphene; and/or the second carbon material includes at least one of carbon black, hard carbon, artificial graphite, natural graphite, carbon quantum dot, carbon fiber, carbon nanotube, carbon nanowire and graphene. When the above two materials are a mixture of various specific materials, the present application does not specifically limit the proportions between respective specific materials.

In a specific embodiment, the positive electrode active layer 3 includes a positive electrode active material. Specifically, the positive electrode active material can be selected from at least one of lithium cobaltate, lithium nickelate, lithium nickel cobalt manganate, lithium manganate, lithium nickel manganate, lithium nickel cobalt aluminate, lithium ferric phosphate, lithium ferric manganese phosphate and lithium-rich manganese-based material. When the positive electrode active material is a mixture of various specific compounds, the present application does not specifically limit the proportions between respective specific compounds.

The positive electrode active layer 3 of the present application further includes a binder and a conductive agent, where the binder can be at least one selected from polyvinylidene fluoride, polytetrafluoroethylene, polyacrylic acid, polyamide, lithium polyacrylate, methacrylate, sodium carboxymethyl cellulose and aluminum dihydrogen phosphate, and the conductive agent can be selected from carbon black, hard carbon, artificial graphite, natural graphite, single-walled carbon nanotube, multi-walled carbon nanotube, graphene, silver powder, nickel powder, tin oxide, conductive titanium dioxide. When the above two kinds of materials are mixtures of various specific materials respectively, the present application does not specifically limit the proportions between respective specific materials.

The source of each component is not limited in the present application, and the commercially available products which are well known to those skilled in the art or the products prepared by conventional preparation methods can be adopted.

The present application is not limited to the preparation method of the positive electrode sheet. For example, the positive electrode sheet is prepared by a method including the following processes:
coating an undercoat layer slurry obtained by mixing and stirring a binder, water, and a first carbon material or a binder, water, a first carbon material and a second carbon material on a surface of a positive electrode current collector 1, and drying to obtain the positive electrode current collector 1 coated with an undercoat layer 2; coating a positive electrode active layer slurry obtained by mixing and stirring a positive electrode active material, a conductive agent, a binder and a solvent on a surface of the undercoat layer 2 far away from the positive electrode current collector, and drying, rolling, slitting and tab welding to obtain the positive electrode sheet.

The method of stirring is not particularly limited in the present application, and for example, a planetary stirrer, a ball mill or a conventional stirring means can be selected.

The coating method of the present application is not particularly limited, and for example, one of extrusion coating, transfer coating, gravure coating and spray coating can be selected.

The solvent of the present application is not particularly limited, and for example, any one of deionized water and N-methylpyrrolidone can be selected.

The surface of the positive electrode sheet obtained by the above preparation method is coated with the undercoat layer 2, which has a good impedance effect and can significantly improve the safety performance and cycle performance of the lithium-ion battery. At the same time, due to the good impedance effect of the undercoat layer 2, it can achieve a higher safety performance at a lower coating thickness, so that the positive electrode sheet can include more positive electrode active materials and reduce the loss of energy density caused by the undercoat layer 2.

A second aspect of that present application provide a lithium-ion battery including an electrolyte, a negative electrode sheet, an isolation film and the positive electrode sheet of the first aspect. The undercoat layer 2 coated on a surface of the positive electrode sheet of the lithium-ion battery has the characteristics of high impedance, low thickness and difficulty in peeling off, so that the lithium-ion battery has good safety performance while reducing the loss of energy density, and the undercoat layer 2 can also include a second carbon material to improve the cycle performance of the lithium-ion battery.

The lithium-ion battery of the present application can be manufactured by a conventional method known to those skilled in the art to which the present application belongs.

The composition of the electrolyte is not particularly limited in the application. For example, it can include a lithium salt, an organic solvent and an additive, where the lithium salt can be selected from at least one of lithium hexafluorophosphate, lithium tetrafluoroborate, lithium difluoro (oxalato) borate, lithium bis(oxalate) borate, lithium bis(fluorosulfonyl)imide, lithium bis(trifluoromethanesulphonyl)imide, lithium difluorophosphate, lithium perchlorate and lithium hexafluoroarsenate; the organic solvent can be selected from at least one of dimethyl carbonate, diethyl carbonate, methyl propyl carbonate, ethyl propyl carbonate, ethylene carbonate, ethyl propionate, ethyl acetate, methyl acetate, dimethyl acetate, methyl butyrate, ethyl butyrate and n-propyl acetate; the additive can be selected from at least one of vinylene carbonate, fluoroethylene carbonate, 1,3-propane sultone, vinyl sulfate, diphenyl carbonate, toluene carbonate, succinic anhydride, succinonitrile and adiponitrile. When each of the above three types of compounds is a mixture of various specific compounds, the present application does not specifically limit the proportions between respective specific compounds.

The present application is not particularly limited to the negative electrode sheet. For example, the negative electrode sheet includes a negative electrode current collector and a negative electrode active material distributed on a surface of the negative electrode current collector, where the negative electrode current collector can be selected from any one of a copper current collector, a nickel current collector and a stainless steel current collector; the negative electrode active material can be selected from at least one of artificial graphite, natural graphite, hard carbon, soft carbon, lithium titanate and silicon anode material. When the negative electrode active material is a mixture of various specific materials, the present application does not specifically limit the proportions between respective specific materials.

The present application is not particularly limited to the isolation film, which can include any material commonly used in lithium batteries, as long as it can separate the positive electrode from the negative electrode and provide a transmission channel for lithium-ions. For example, it can be selected from one of glass fiber microporous film, polyester microporous film, polyethylene microporous film, polypropylene microporous film, polytetrafluoroethylene microporous film and ceramic-coated isolation film.

Hereinafter, the positive electrode sheet of the present application will be described in detail through specific Examples.

### Example 1

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.552 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 0.5 μm.

### Example 2

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 90-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 2.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 1 μm.

### Example 3

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 70-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 5.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 3 μm.

### Example 4

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.562 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 50-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 8.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 4 μm.

### Example 5

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 50-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 10.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example is obtained, where a thickness of the undercoat layer in the positive electrode sheet is 5 μm.

### Example 6

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 28%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 50-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 14.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 8 μm.

### Example 7

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 302 cm and a carbon content of 95%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 0.5 μm.

### Example 8

(1) 40 wt % of carbon black with a median particle size of 80 nm as a first carbon material, and 60 wt % of lithium polyacrylate and water are added into a planetary stirrer and uniformly stirred to obtain an undercoat layer slurry with a solid content of 8%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, and the undercoat layer slurry is coated on both surfaces of the aluminum foil using a 60-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 0.4 μm.

### Example 9

(1) 94 wt % of carbon black with a median particle size of 80 nm as a first carbon material, and 6 wt % of lithium polyacrylate and water are added into a planetary stirrer and uniformly stirred to obtain an undercoat layer slurry with a solid content of 15%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 0.6 μm.

### Example 10

(1) 65 wt % of carbon black with a median particle size of 80 nm as a first carbon material, 5 wt % of conductive carbon black with a median particle size of 50 nm as a second carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.502 cm and a carbon content of 97%, and the conductive carbon black as the second carbon material has a powder resistivity of 0.0252 cm; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 0.5 μm.

### Example 11

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 10%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 0.5 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 0.3 μm.

### Example 12

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.252 cm and a carbon content of 98.5%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 0.5 μm.

### Example 13

(1) 70 wt % of hard carbon with a median particle size of 500 nm as a first carbon material, and 30 wt % of lithium polyacrylate and water are added into a planetary stirrer and uniformly stirred to obtain an undercoat layer slurry with a solid content of 20%, where, the hard carbon as the first carbon material has a powder resistivity of 32 cm and a carbon content of 95%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 90-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 3.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 3 μm.

### Example 14

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.52 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 130-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 0.3 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 0.2 μm.

### Example 15

(1) 96 wt % of carbon black with a median particle size of 80 nm as a first carbon material, and 4 wt % of lithium polyacrylate and water are added into a planetary stirrer and uniformly stirred to obtain an undercoat layer slurry with a solid content of 15%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 0.5 μm.

### Example 16

(1) 30 wt % of carbon black with a median particle size of 80 nm as a first carbon material, and 70 wt % of lithium polyacrylate and water are added into a planetary stirrer and uniformly stirred to obtain an undercoat layer slurry with a solid content of 15%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet is obtained, where a thickness of the undercoat layer in the positive electrode sheet is 0.5 μm.

### Example 17

(1) 70 wt % of hard carbon with a median particle size of 1100 nm as a first carbon material, and 30 wt % of lithium polyacrylate and water are added into a planetary stirrer and uniformly stirred to obtain an undercoat layer slurry with a solid content of 20%, where, the hard carbon as the first carbon material has a powder resistivity of 402 cm and a carbon content of 95%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 90-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 3.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 3 μm.

### Example 18

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 5502 cm and a carbon content of 80%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 0.5 μm.

### Example 19

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 4002 cm and a carbon content of 78%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 0.5 μm.

### Example 20

(1) 65 wt % of carbon black with a median particle size of 80 nm as a first carbon material, 5 wt % of conductive hard carbon with a median particle size of 1100 nm as a second carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.502 cm and a carbon content of 97%, and a powder resistivity of the conductive hard carbon as the second carbon material is 0.02552 cm; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 1.2 μm.

### Example 21

(1) 48 wt % of carbon black with a median particle size of 80 nm as a first carbon material, 22 wt % of conductive carbon black with a median particle size of 50 nm as a second carbon material, and 30 wt % of lithium polyacrylate and water are added into a planetary stirrer and uniformly stirred to obtain an undercoat layer slurry with a solid content of 15%; where, the carbon black as the first carbon material has a powder resistivity of 0.552 cm and a carbon content of 97%, and a powder resistivity of the conductive carbon black as the second carbon material is 0.0252 cm; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 0.5 μm.

### Example 22

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.552 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 35%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 0.5 μm.

### Example 23

(1) 70 wt % of carbon black with a median particle size of 80 nm as a first carbon material, and 30 wt % of lithium polyacrylate and water are added into a planetary stirrer and uniformly stirred to obtain an undercoat layer slurry with a solid content of 32%, where, the carbon black as the first carbon material has a powder resistivity of 0.562 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 50-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 15.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 9 μm.

### Example 24

(1) 70 wt % of carbon black with a median particle size of 90 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 2002 cm and a carbon content of 93%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 0.5 μm.

### Example 25

(1) 70 wt % of carbon black with a median particle size of 90 nm as a first carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 2252 cm and a carbon content of 92.5%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 0.5 μm.

### Example 26

(1) 70 wt % of carbon black with a median particle size of 80 nm as a first carbon material, and 30 wt % of polyvinylidene fluoride and N-methylpyrrolidone are added into a planetary stirrer and uniformly stirred to obtain an undercoat layer slurry with a solid content of 15%, where, the carbon black as the first carbon material has a powder resistivity of 0.502 cm and a carbon content of 97%; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet, where a thickness of the undercoat layer in the positive electrode sheet is 0.5 μm.

### Example 27

(1) 28 wt % of carbon black with a median particle size of 80 nm as a first carbon material, 42 wt % of conductive carbon black with a median particle size of 50 nm as a second carbon material, and 30 wt % of lithium polyacrylate and water are added into a planetary stirrer and uniformly stirred to obtain an undercoat layer slurry with a solid content of 15%, where, the carbon black as the first carbon material has a powder resistivity of 0.502 cm and a carbon content of 97%, and a powder resistivity of the conductive carbon black as the second carbon material is 0.02 Ω·cm; lithium cobaltate as a positive electrode active material, carbon black as a conductive agent and polyvinylidene fluoride as a binder are mixed according to a mass ratio of 96:1.5:2.5, added into N-methylpyrrolidone, and uniformly stirred by a planetary stirrer to obtain a positive electrode active layer slurry;
(2) an aluminum foil with a thickness of 10 μm is selected as a positive electrode current collector, the undercoat layer slurry is coated on both surfaces of the aluminum foil using a 100-mesh gravure coater such that an area proportion of the undercoat layer relative to the surface of the positive electrode current collector is 90%; after drying the coated aluminum foil at 80° C., an electrode sheet coated with the undercoat layer is obtained, where an areal density of the undercoat layer is 1.0 g/m²; the positive electrode active layer slurry is coated on a surface of the undercoat layer far away from the aluminum foil by an extrusion coater and then dried, and an electrode sheet coated with the undercoat layer and the positive electrode active layer is obtained; then, the electrode sheet coated with the undercoat layer and the positive electrode active layer is subjected to rolling, slitting and tab welding to obtain a positive electrode sheet of the present example, where a thickness of the undercoat layer in the positive electrode sheet is 0.5 μm.

### Comparative Example 1

The preparation method of the lithium-ion battery in the present comparative example is basically the same as that in Example 1, except that the powder resistivity of the carbon black as the first carbon material included in the undercoat layer is 0.1 Ω·cm.

### Comparative Example 2

The preparation method of the lithium-ion battery in the present comparative example is basically the same as that in Example 1, except that the positive electrode sheet herein does not contain the undercoat layer.

### TEST EXAMPLES

1. The particle sizes of the first carbon material and the second carbon material used in the above Examples and Comparative Examples and the carbon content of the first carbon material are tested. Table 1 shows the compositions and test results of the positive electrode sheets in the above Examples and Comparative Examples.
2. The positive electrode sheets prepared in the above Examples and Comparative Examples are applied to lithium-ion batteries, and the specific preparation steps are as follows:
artificial graphite, carbon black as a conductive agent and styrene-butadiene rubber are mixed according to a mass ratio of 96:1:3, added into water, and stirred evenly with a planetary stirrer to obtain a negative electrode slurry; a copper foil with a thickness of 6 μm is selected as a negative electrode current collector, and the negative electrode slurry is coated on both surfaces of the copper foil by an extrusion coater and dried to obtain an electrode sheet coated with a negative electrode active layer; the electrode sheet is subjected to rolling, slitting and tab welding to obtain a negative electrode sheet; the negative electrode sheet, respective positive electrode sheets prepared in the above Examples and Comparative Examples and the isolation film are wound in sequence to form a winding core, and the battery core is subjected to packaging, baking, electrolyte injection, formation and sorting, thereby obtaining a lithium-ion battery including corresponding positive electrode sheet in the above Examples and Comparative Examples.

Safety under acupuncture, safety under heavy object impact and cycle performance of the lithium-ion batteries including the positive electrode sheets of the above Examples and Comparative Examples are tested.

### (1) Safety Under Acupuncture

When a battery cell is charged to 100% SOC (State of Charge), a tungsten steel needle with a diameter of 2.5 mm, a length of 100 mm and a tip cone angle of 45° is used to piercing through a geometric center of the battery cell at a speed of 150 mm/s and retained for 10 min; if the battery cell does not cause smoke, catch fire or explode, it will be considered as being qualified; 10 battery cells will be tested in each group, and a qualification rate will be considered as meeting the requirement if a number of the qualified battery cells is no less than 7.

### (2) Safety Under Heavy Object Impact

When a battery cell is charged to 80% SOC, the battery cell is placed on a plane, a bar with a diameter of 15.8 mm is placed transversely in the middle of the battery cell, and a heavy object with a weight of 9.1 kg is used to make a free-falling motion at a height of 630 mm to impact the battery cell; if the battery does not cause smoke, catch fire or explode, it will be considered as being qualified; 10 battery cells will be tested in each group, and a qualification rate will be considered as meeting the requirement if the number of the qualified battery cells is no less than 7.

### (3) Cycle Performance Under Normal Temperature

At 25° C., a battery is charged to a cut-off voltage at a constant current of 0.7 C, then the battery is charged at a constant voltage of this cut-off voltage, after the current reaches a cut-off current of 0.025 C, the battery is discharged to 3.0V at a constant current of 0.5 C; after 800 times of charging-and-discharging cycles in such mode, a capacity retention rate is calculated, and 5 batteries are tested in each group to take an average value.

The test results are shown in Table 2

TABLE 1

| | Mass percentage | Mass percentage | Mass | Median particle | Median particle | Area | Carbon | | |
|---|---|---|---|---|---|---|---|---|---|
| | content of | content of | percentage | size of | size of | proportion | content of | Solid | |
| | first carbon | second carbon | content of | first carbon | second carbon | of undercoat | first carbon | Content | Mesh |
| | material wt % | material wt % | binder wt % | material nm | material nm | layer % | material % | % | number |
| Example 1 | 70 | / | 30 | 80 | / | 90 | 97 | 15 | 100 |
| Example 2 | 70 | / | 30 | 80 | / | 90 | 97 | 15 | 90 |
| Example 3 | 70 | / | 30 | 80 | / | 90 | 97 | 15 | 70 |
| Example 4 | 70 | / | 30 | 80 | / | 90 | 97 | 15 | 50 |
| Example 5 | 70 | / | 30 | 80 | / | 90 | 97 | 15 | 50 |
| Example 6 | 70 | / | 30 | 80 | / | 90 | 97 | 28 | 50 |
| Example 7 | 70 | / | 30 | 80 | / | 90 | 95 | 15 | 100 |
| Example 8 | 40 | / | 60 | 80 | / | 90 | 97 | 8 | 60 |
| Example 9 | 94 | / | 6 | 80 | / | 90 | 97 | 15 | 100 |
| Example 10 | 65 | 5 | 30 | 80 | 50 | 90 | 97 | 15 | 100 |
| Example 11 | 70 | / | 30 | 80 | / | 90 | 97 | 10 | 100 |
| Example 12 | 70 | / | 30 | 80 | / | 90 | 98.5 | 15 | 100 |
| Example 13 | 70 | / | 30 | 500 | / | 90 | 95 | 20 | 90 |
| Example 14 | 70 | / | 30 | 80 | / | 90 | 97 | 15 | 130 |
| Example 15 | 96 | / | 4 | 80 | / | 90 | 97 | 15 | 100 |
| Example 16 | 30 | / | 70 | 80 | / | 90 | 97 | 15 | 100 |
| Example 17 | 70 | / | 30 | 1100 | / | 90 | 95 | 20 | 90 |
| Example 18 | 70 | / | 30 | 80 | / | 90 | 80 | 15 | 100 |
| Example 19 | 70 | / | 30 | 80 | / | 90 | 78 | 15 | 100 |
| Example 20 | 65 | 5 | 30 | 80 | 1100 | 90 | 97 | 15 | 100 |
| Example 21 | 48 | 22 | 30 | 80 | 50 | 90 | 97 | 15 | 100 |
| Example 22 | 70 | / | 30 | 80 | / | 35 | 97 | 15 | 100 |
| Example 23 | 70 | / | 30 | 80 | / | 90 | 97 | 32 | 50 |
| Example 24 | 70 | / | 30 | 90 | | 90 | 93 | 15 | 100 |
| Example 25 | 70 | / | 30 | 90 | | 90 | 92.5 | 15 | 100 |
| Example 26 | 70 | / | 30 | 80 | / | 90 | 97 | 15 | 100 |
| Example 27 | 28 | 42 | 30 | 80 | 50 | 90 | 97 | 15 | 100 |
| Comparative | 70 | / | 30 | 80 | / | 90 | 97 | 15 | 100 |
| Example 1 | | | | | | | | | |
| Comparative | / | / | / | / | / | / | / | / | / |
| Example 2 | | | | | | | | | |

TABLE 2

| | Powder resistivity | Powder resistivity | Areal density | Thickness of | | Safety under | Capacity | Energy |
|---|---|---|---|---|---|---|---|---|
| | of first carbon | of second carbon | of undercoat | undercoat | Safety under | heavy object | retention | density |
| | material Ω · cm | material Ω · cm | layer g/m² | layer μm | acupuncture | impact | rate % | Wh/kg |
| Example 1 | 0.5 | / | 1.0 | 0.5 | 9/10 | 9/10 | 86.98 | 270.1 |
| Example 2 | 0.5 | / | 2.0 | 1 | 10/10 | 9/10 | 86.59 | 269.3 |
| Example 3 | 0.5 | / | 5.0 | 3 | 10/10 | 10/10 | 86.25 | 267.7 |
| Example 4 | 0.5 | / | 8.0 | 4 | 10/10 | 10/10 | 86.07 | 266.3 |
| Example 5 | 0.5 | / | 10.0 | 5 | 10/10 | 10/10 | 85.78 | 265.1 |
| Example 6 | 0.5 | / | 14 | 8 | 10/10 | 10/10 | 85.66 | 263.0 |
| Example 7 | 3 | / | 1.0 | 0.5 | 10/10 | 10/10 | 86.34 | 270.0 |
| Example 8 | 0.5 | / | 1.0 | 0.4 | 9/10 | 10/10 | 85.54 | 270.1 |
| Example 9 | 0.5 | / | 1.0 | 0.6 | 7/10 | 8/10 | 87.24 | 270.1 |
| Example 10 | 0.5 | 0.02 | 1.0 | 0.5 | 8/10 | 9/10 | 87.32 | 270.0 |
| Example 11 | 0.5 | / | 0.5 | 0.3 | 7/10 | 3/10 | 87.31 | 270.3 |
| Example 12 | 0.2 | / | 1.0 | 0.5 | 8/10 | 8/10 | 87.21 | 270.0 |
| Example 13 | 3 | / | 3.0 | 3 | 10/10 | 10/10 | 86.55 | 268.8 |
| Example 14 | 0.5 | / | 0.3 | 0.2 | 6/10 | 4/10 | 87.42 | 270.4 |
| Example 15 | 0.5 | / | 1.0 | 0.5 | 6/10 | 4/10 | 86.74 | 270.1 |
| Example 16 | 0.5 | / | 1.0 | 0.5 | 9/10 | 10/10 | 83.59 | 270.1 |
| Example 17 | 4 | / | 3.0 | 3 | 5/10 | 4/10 | 86.74 | 267.7 |
| Example 18 | 55 | / | 1.0 | 0.5 | 10/10 | 10/10 | 85.08 | 270.1 |
| Example 19 | 40 | / | 1.0 | 0.5 | 10/10 | 10/10 | 85.23 | 270.1 |
| Example 20 | 0.5 | 0.025 | 1.0 | 1.2 | 10/10 | 10/10 | 87.10 | 269.1 |
| Example 21 | 0.5 | 0.02 | 1.0 | 0.5 | 5/10 | 6/10 | 87.51 | 270.0 |
| Example 22 | 0.5 | / | 1.0 | 0.5 | 3/10 | 5/10 | 87.34 | 269.5 |
| Example 23 | 0.5 | / | 15 | 9 | 10/10 | 10/10 | 85.45 | 262.6 |
| Example 24 | 20 | / | 1.0 | 0.5 | 10/10 | 10/10 | 86.20 | 270.1 |
| Example 25 | 22 | / | 1.0 | 0.5 | 10/10 | 10/10 | 85.93 | 270.0 |
| Example 26 | 0.5 | / | 1.0 | 0.5 | 10/10 | 10/10 | 86.69 | 270.1 |
| Example 27 | 0.5 | 0.02 | 1.0 | 0.5 | 3/10 | 2/10 | 87.42 | 270.0 |
| Comparative | 0.1 | / | 1.0 | 0.5 | 3/10 | 2/10 | 83.28 | 262.0 |
| Example 1 | | | | | | | | |
| Comparative | / | / | / | / | 0/10 | 1/10 | 82.39 | 261.9 |
| Example | | | | | | | | |

As can be seen from Table 1 and Table 2:
(1) From Examples 1-27 and Comparative Example 2, it can be seen that the safety under acupuncture and the safety under heavy object impact of lithium-ion battery can be significantly improved by adding an undercoat layer between a surface of the positive electrode current collector and an active material layer. As can be explained from the above, when mechanical abuse such as acupuncture or heavy object impact occurs, a first carbon material with high resistivity included in the undercoat layer can move to a short-circuit point, thereby improving short-circuit resistance, making the lithium-ion battery less prone to thermal runaway, reducing battery fire and explosion and so on, and improving the safety performance of the lithium-ion battery. From Examples 1-6, it can be seen that with a gradual increase of an areal density and thickness of the undercoat layer, the safety performance of the lithium-ion battery is also gradually improved, and its capacity retention rate is only slightly reduced.
(2) According to Example 1 and Example 7, it can be seen that the safety performance of lithium-ion battery is better after a powder resistivity of the first carbon material is improved, but its cycle performance is slightly reduced; from Example 1 and Example 12, it can be seen that the safety performance of the lithium-ion battery is slightly reduced after the powder resistivity of the first carbon material is reduced to 0.262·cm, but the qualification rate is still high. According to Example 1 and Comparative Example 1, when the powder resistivity of the first carbon material is lower than 0.252 cm, the safety performance of the lithium-ion battery will drop sharply due to the too low powder resistivity of the first carbon material particles, resulting in an insufficient electron barrier effect on mechanical abuse.

With reference to the above analysis, it can be seen that the lithium-ion battery including the positive electrode sheet of the present application has obviously improved safety performance, and it also has good cycle performance while reducing the loss in energy density.

Finally, it should be noted that the above Examples are only used to illustrate the technical solutions of the present application, not to limit them; although the present application has been described in detail with reference to the foregoing examples, those of ordinary skill in the art should understand that: the technical solutions described in the foregoing examples can still be modified, or some or all of the technical features therein can be equivalently replaced; and these modifications or replacements do not make the essence of the corresponding technical solutions deviate from the scope of the technical solutions of the embodiments of the present application.

What is claimed is:

1. A positive electrode sheet, comprising a positive electrode current collector, an undercoat layer and a positive electrode active layer, the undercoat layer being located on at least one surface of the positive electrode current collector, and the positive electrode active layer being located on a surface of the undercoat layer far away from the positive electrode current collector;
the undercoat layer comprises a first carbon material;
a powder resistivity of the first carbon material is not lower than 0.2 Ω·cm.

2. The positive electrode sheet according to claim 1, wherein the powder resistivity of the first carbon material is 0.2-100 Ω·cm, and/or an areal density of the undercoat layer is 0.5-14 g/m².

3. The positive electrode sheet according to claim 1, wherein the undercoat layer further comprises a binder;
a mass percentage content of the binder in the undercoat layer is 6-60 wt %; and/or,
the binder comprises at least one of polyvinylidene fluoride, polytetrafluoroethylene, polyacrylic acid, polyamide, polyacrylic acid, lithium polyacrylate, methacrylate, sodium carboxymethyl cellulose and aluminum dihydrogen phosphate.

4. The positive electrode sheet according to claim 3, wherein the powder resistivity of the first carbon material is 0.2-100 Ω·cm, and/or an areal density of the undercoat layer is 0.5-14 g/m².

5. The positive electrode sheet according to claim 1, wherein a median particle size of the first carbon material is ≤1000 nm;
and/or a carbon content of the first carbon material is more than 80%;
and/or a mass percentage content of the first carbon material in the undercoat layer is not lower than 40%.

6. The positive electrode sheet according to claim 5, wherein the powder resistivity of the first carbon material is 0.2-100 Ω·cm, and/or an areal density of the undercoat layer is 0.5-14 g/m².

7. The positive electrode sheet according to claim 5, wherein the undercoat layer further comprises a binder;
a mass percentage content of the binder in the undercoat layer is 6-60 wt %; and/or,
the binder comprises at least one of polyvinylidene fluoride, polytetrafluoroethylene, polyacrylic acid, polyamide, polyacrylic acid, lithium polyacrylate, methacrylate, sodium carboxymethyl cellulose and aluminum dihydrogen phosphate.

8. The positive electrode sheet according to claim 7, wherein the powder resistivity of the first carbon material is 0.2-100 Ω·cm, and/or an areal density of the undercoat layer is 0.5-14 g/m².

9. The positive electrode sheet according to claim 1, wherein the undercoat layer further comprises a second carbon material;
a powder resistivity of the second carbon material is <0.2 Ω·cm;
and/or a median particle size of the second carbon material is ≤1000 nm;
and/or a mass percentage content of the second carbon material in the undercoat layer is not greater than 20%.

10. The positive electrode sheet according to claim 9, wherein the powder resistivity of the first carbon material is 0.2-100 Ω·cm, and/or an areal density of the undercoat layer is 0.5-14 g/m².

11. The positive electrode sheet according to claim 9, wherein the undercoat layer further comprises a binder;
a mass percentage content of the binder in the undercoat layer is 6-60 wt %; and/or,
the binder comprises at least one of polyvinylidene fluoride, polytetrafluoroethylene, polyacrylic acid, polyamide, polyacrylic acid, lithium polyacrylate, methacrylate, sodium carboxymethyl cellulose and aluminum dihydrogen phosphate.

12. The positive electrode sheet according to claim 11, wherein the powder resistivity of the first carbon material is 0.2-100 Ω·cm, and/or an areal density of the undercoat layer is 0.5-14 g/m².

13. The positive electrode sheet according to claim 5, wherein the undercoat layer further comprises a second carbon material;
a powder resistivity of the second carbon material is <0.2 Ω·cm;
and/or a median particle size of the second carbon material is ≤1000 nm;
and/or a mass percentage content of the second carbon material in the undercoat layer is not greater than 20%.

14. The positive electrode sheet according to claim 13, wherein the powder resistivity of the first carbon material is 0.2-100 Ω·cm, and/or an areal density of the undercoat layer is 0.5-14 g/m².

15. The positive electrode sheet according to claim 13, wherein the undercoat layer further comprises a binder;
a mass percentage content of the binder in the undercoat layer is 6-60 wt %; and/or,
the binder comprises at least one of polyvinylidene fluoride, polytetrafluoroethylene, polyacrylic acid, polyamide, polyacrylic acid, lithium polyacrylate, methacrylate, sodium carboxymethyl cellulose and aluminum dihydrogen phosphate.

16. The positive electrode sheet according to claim 9, wherein a mass percentage content of the first carbon material in the undercoat layer is greater than that of the second carbon material;
a mass ratio of the second carbon material to the first carbon material is (0:100)-(40:100);
and/or, the undercoat layer comprises the following components by mass percentage content: 40-94% of the first carbon material, 0-20% of the second carbon material and 6-60% of a binder.

17. The positive electrode sheet according to claim 1, wherein an area proportion of the undercoat layer relative to the surface of the positive electrode current collector is ≥40%, and/or a thickness of the undercoat layer is ≤8 μm.

18. The positive electrode sheet according to claim 9, wherein the first carbon material comprises at least one of carbon black, hard carbon, artificial graphite, natural graphite, carbon quantum dot, carbon fiber, carbon nanotube, carbon nanowire and graphene;
and/or the second carbon material comprises at least one of carbon black, hard carbon, artificial graphite, natural graphite, carbon quantum dot, carbon fiber, carbon nanotube, carbon nanowire and graphene.

19. The positive electrode sheet according to claim 1, wherein the positive electrode active layer comprises a positive electrode active material;
the positive electrode active material comprises at least one of lithium cobaltate, lithium nickelate, lithium nickel cobalt manganate, lithium manganate, lithium nickel manganate, lithium nickel cobalt aluminate, lithium ferric phosphate, lithium ferric manganese phosphate and lithium-rich manganese.

20. A lithium-ion battery, comprising the positive electrode sheet according to claim 1.
